(19) United States
(12) Patent Application Publication
(10) Pub. No.: US 2004/0057540 A1
(43) Pub. Date: Mar. 25, 2004

(54) Method for synchronizing a radio receiver to radio signals

(76) Inventor: Frank Naberfeld, Dortmund (DE)

Correspondence Address: KENYON & KENYON, ONE BROADWAY, NEW YORK, NY, 10004, US

(21) Appl. No.: 10/416,070

(22) PCT Filed: Oct. 9, 2001
(86) PCT No.: PCT/DE01/03860

(30) Foreign Application Priority Data
Nov. 7, 2000 (DE) 10055087.8

(51) Int. Cl. H04L 7/00

(52) U.S. Cl. 375/354

(57) ABSTRACT

A method is proposed for synchronizing a radio receiver to radio signals, a position-finding signal, preferably a GPS signal, is used to correct the synchronization of the radio receiver to the received radio signals. In this context, the correction is carried out using a filter which can preferably be a Kalman filter. A velocity vector is defined using the position-finding device, and/or the onboard clock pulse is corrected, if indicated.

### BACKGROUND INFORMATION

The present invention is directed a method for synchronizing a radio receiver to radio signals according to the definition of the species in the independent claim.

In the context of DAB (digital audio broadcasting), it is already known to perform a rough time synchronization on the basis of a zero symbol which represents the beginning of each DAB frame. This can be accomplished, for example, by taking a power measurement, since the zero symbol, as its name indicates, does not have any signal power. A more precise synchronization is carried out in the context of DAB through the use of the TFPR symbols periodically placed in the DAB data stream. These TFPR symbols, also called phase-reference symbols, are autocorrelation sequences, for which the so-called CAZAC sequences are used, in particular. The correlation properties of these CAZAC sequences are such that, in response to correspondence, a high autocorrelation signal is output, and in response to a lack of correspondence, a zero is output as an autocorrelation signal. Using the TFPR signal, it is then possible to ascertain the frequency offset caused by a non-ideal clock frequency in the radio receiver, a Doppler shift resulting from a movement of the radio receiver or a frequency offset of the transmitter.

In addition, using the TFPR symbol, it is also possible to determine the channel pulse response, which can be used to determine the time deviation and other signal parameters. Then, using a so-called FFT (fast fourier transform), the time deviation, frequency deviation, and phase deviation can be determined in order to correct these deviations.

### SUMMARY OF THE INVENTION

In contrast, the method according to the present invention for synchronizing a radio receiver to radio signals, having the features of the independent claim, has the advantage that, by using the position-finding signal, preferably a GPS (global positioning system) signal, it is possible to determine a precise point in time and, thus, a precise timing clock pulse, so that once a rough synchronization is performed, a fixed timing clock pulse is available which may be optionally used to correct the onboard clock pulse of the radio receiver. Using the position-finding signal, velocity vectors may also be defined, in order to correct a Doppler shift in the frequency of the radio signals. On the whole, this considerably improves the synchronization, above all, because GPS and DAB are uncorrelated methods, so that a systematic error in a transmission method does not affect the correction signals in the radio receiver. As a result, the audio quality or the quality of the received data is considerably enhanced. There is no longer a need then for a rough synchronization to the DAB data stream following a loss of a DAB signal, since, using the timing clock pulse of the position-finding signal (GPS signal), the clock pulse of the frame may be sustained and, consequently, the synchronization maintained.

Advantageous improvements to the method set forth in the independent claim for synchronizing a radio receiver to radio signals are rendered possible by the measures and further refinements delineated in the dependent claims.

It is especially beneficial that the correction performed on the basis of the position-finding signals is carried out using a filter, preferably a predictor. A Kalman filter may then be used, which has excellent properties for this purpose. When working with a predictor, a prediction of a message signal is requested, thus a negative dead time. The term Kalman filter denotes a computational method which defines an estimate for a corrupted measurable variable. In particular, the Kalman filter is recursive and may be implemented on a processor.

To implement the method, it is, moreover, advantageous that a radio receiver be available which is able to be connected to a position-finding device, such as a GPS receiver, and which has a correction unit, the Kalman filter, which may be used to correct the synchronization of the received radio signals.

### BRIEF DESCRIPTION OF THE DRAWING

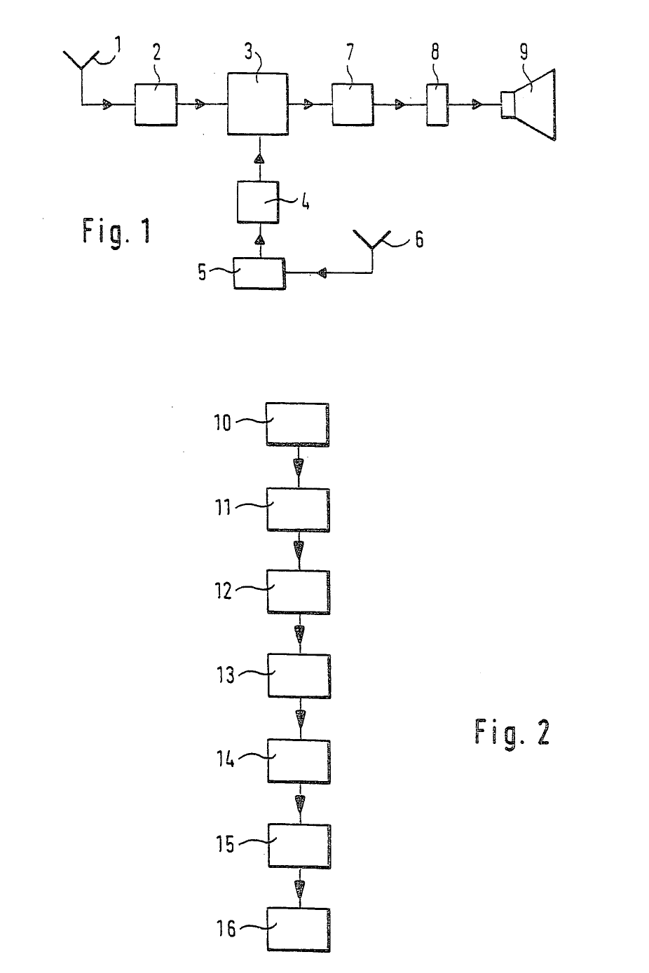

Exemplary embodiments of the present invention are illustrated in the drawing and are explained in detail in the following description. FIG. 1 shows a block diagram of the radio receiver according to the present invention, and FIG. 2 a flow chart of the method according to the present invention.

### DETAILED DESCRIPTION

In the context of digital radio signals, the synchronization in the radio receiver is of decisive importance for the quality of the received data. When working with digital radio signals, as is the case, for example, in DAB, this synchronization is initially carried out as a rough synchronization and then as a precise synchronization. The rough synchronization does not suffice for decoding the DAB signal in the most error-free possible way, since the mobile radio channel causes considerable power fluctuations in the DAB radio signal. Moreover, the set receiving frequency must be synchronized very precisely to the frequency actually emitted. Another problem is posed by the onboard clock pulse. If the onboard clock pulse of the receiver is too far removed from the ideal frequency, a synchronization is not possible in the first place.

Since the quality of the received DAB signals in the mobile radio channel fluctuates greatly, the calculation of the deviation values employing precise synchronization using a TFPR symbol is faulty. In the process, the error may become so great that the time and frequency offset also increase to the point where no more valid values are able to be calculated from the next TFPR symbol. In such a case, the synchronization stalls, so that a rough synchronization is required once more on the basis of the zero symbol. Concomitant with this, the wanted signals, thus the audio or multimedia data, exhibit an increasing bit error rate, which can become so great that the useful signals become unusable.

For that reason, in accordance with the present invention, the deviations calculated using the TFPR symbol themselves undergo a correction, which is based on a received position-finding signal. In this context, the known GPS signal is used as a position-finding signal. However, other position-finding signals are also possible which render possible a precise determination of time. The GPS signal provides a very precise time reference and, generically, a very precise positional determination. Both pieces of information may be used to improve the DAB synchronization. This requires a preprocessing, since a velocity vector is first calculable from the positional data on the basis of a time derivation. Moreover, the actual onboard clock-pulse frequency may be determined from the GPS time and the setpoint frequency of the onboard clock pulse. In this context, a counter is preferably used which counts a predefined oscillation or clock pulse on the basis of the GPS time and the onboard clock pulse, and then undertakes a comparison. It suffices, in this context, when the DAB receiver receives a GPS-precise time: it is then able to itself calculate the deviation of its onboard clock pulse from the ideal. When synchronizing for the first time to the DAB data stream, as described above, merely a rough time synchronization is possible. If the actual pulse frequency is known, the above described frequency-correction unit may be adjusted already before receipt of the first DAB data in a way that allows the non-ideal onboard clock pulse to already be compensated for the first data. In this way, the first synchronization is clearly accelerated and, in another frame, is now independent of the clock-pulse frequency.

Another aspect involves the use of the precise timing clock pulse of the GPS receiver for purposes of time synchronization. Many DAB transmitter networks are already synchronized by GPS. In these cases, the timing clock pulse of the GPS receiver may be used directly, provided that the radio receiver is not moving. This information is supplied by the GPS receiver circuitously, by way of the positional data. When working with receivers in motion, the TFPR analysis merely needs to eliminate the additional deviations caused by the movement. If the power of the DAB signal drops to the point where it is no longer possible to decode the TFPR symbol, then the GPS timing clock pulse is able to maintain the synchronization to the extent that, when the DAB signal is used again, there is no longer a need for a rough time synchronization using the zero symbol.

The velocity information ascertained from the positional data may contribute in another manner to improving the DAB synchronization. Since the Doppler shift is merely dependent upon the receiving frequency and the relative velocity between the transmitter and receiver, it is possible to calculate the maximum Doppler shift that may occur in response to the active values. This information may be incorporated, in turn, in the error detection of the correction-value calculation. The correction-value calculation is preferably performed using a filter, a predictor, and, in this case, a Kalman filter is used. Such a filter may be implemented on a digital signal processor.

FIG. 1 shows a block diagram of the radio receiver according to the present invention. An antenna 1 is connected to an input of a high-frequency reception unit 2. An output of high-frequency receiver 2 is connected to a first input of a processor 3. A processor 4 is connected to a second input of processor 3. An output of processor 3 leads to an audio decoding 7, whose output is connected, in turn, to an audio amplifier 8. Audio amplifier 8 is connected, in turn, to an input of a loudspeaker 9. A GPS receiver 5 is connected to an input of processor 4. An antenna 6 is connected to an input of GPS receiver 5.

The radio signals received by antenna 1 are amplified, filtered, undergo infradyne mixing to an intermediate frequency, as well as digitized by high-frequency receiver 2. The thus created digital data stream is then first checked by processor 3 for a possible synchronization. For this, in response to the first receipt of the DAB signal, processor 3 performs a rough synchronization using the zero symbol in the DAB frame. Following a successful rough time synchronization, processor 3 performs a precise synchronization using the TFPR symbol and, in the process, determines the frequency offset, the time offset, and a possible phase shift. The GPS signals, transmitted by various satellites, are received by antenna 6 and evaluated in GPS receiver 5. Thus, GPS receiver 5 supplies the instantaneous position of the radio receiver according to the present invention and a precise timing clock pulse to processor 4. From the GPS data, processor 4 calculates a velocity vector by evaluating successive positional determinations for the radio receiver, and processor 4 determines whether the onboard clock pulse of the radio receiver according to the present invention corresponds to the set value. These data are then transmitted to processor 3, so that, through the use of a filter and, in fact a predictor, here a Kalman filter, processor 3 undertakes the correction of the frequency offset, time offset, and phase offset. The thus synchronized DAB data are then transmitted to audio decoding 7, which performs the audio decoding on the DAB data. This audio decoding 7 is implemented here to attain a higher speed in the hardware, this also being attainable on a processor. The digital audio data are then converted by audio decoding 7 into analog audio signals, to then be transmitted to audio amplifier 8, which amplifies the audio signals, so that they may be reproduced by loudspeaker 9.

In FIG. 2, the method according to the present invention is represented as a flow chart. In method step 10, the digital radio signals, thus the DAB signals are received, and a rough synchronization to the zero symbol follows. In method step 11, the precise synchronization using the TFPR symbol is carried out in processor 3, in order to calculate the frequency offset, time offset, and phase offset. In method step 12, the GPS data are determined using GPS receiver 5 and antenna 6, so that GPS receiver 5 is able to ascertain the active position and the exact timing clock pulse. Thus, in method step 13, the onboard clock pulse of the radio receiver according to the present invention and the velocity of the radio receiver according to the present invention are determined. These data are then used in method step 14 to correct the frequency offset, time offset, and phase offset. In method step 15, the synchronized data are processed in that a channel and source coding is undertaken. In method step 16, the audio data are reproduced.

It is alternatively possible that DAB is used to receive multimedia data, which are then decoded accordingly and reproduced on a display or on a loudspeaker.

What is claimed is:

1. A method for synchronizing a radio receiver to radio signals, at least one reference symbol being used periodically in the radio signals for purposes of synchronization by the radio receiver,
wherein the synchronization of the radio receiver is corrected as a function of the position-finding signal received by the radio receiver.

2. The method as recited in claim 1,
wherein a filter is used to correct the synchronization.

3. The method as recited in claim 1 or 2,
wherein a rough synchronization is achieved using a first reference symbol, and a precise synchronization is achieved using a second reference symbol.

4. The method as recited in claim 3,
wherein the zero symbol is used as the first reference symbol, and the TFPR symbol is used as the second reference symbol.

5. The method as recited in one of the preceding claims,
wherein on the basis of the received position-finding signal, an onboard clock pulse and/or a velocity vector of the radio receiver is defined to correct the synchronization.

6. The method as recited in one of the preceding claims,
wherein a GPS signal is used as the position-finding signal.

7. A radio receiver for carrying out the method as recited in one of claims 1 through 6,
wherein the radio receiver is connectible to a position-finding device (5, 6) and has a correction unit (4, 3), which, as a function of received position-finding signals, corrects the synchronization of the received radio signals.

8. The radio receiver as recited in claim 7,
wherein the correction unit is a Kalman filter.
